(19) United States
(12) Patent Application Publication
(10) Pub. No.: US 2010/0159924 A1
(43) Pub. Date: Jun. 24, 2010

(54) IMSI handling system

(75) Inventors: Mikael Lagerman, Goteborg (SE); Hassan Alaoui, Stockholm (SE); Jan Arwald, Sollentuna (SE); Anders Bäckman, Goteborg (SE); Tony Antonius Saers, Stockholm (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/520,439

(22) PCT Filed: Dec. 21, 2006
(86) PCT No.: PCT/SE2006/050617

§ 371 Date: Jan. 8, 2010

(51) Int. Cl. H04W 8/04

(52) U.S. Cl. 455/433

(57) ABSTRACT

The invention relates to an International Mobile Subscriber Identity, IMSI, handling system (1) for a cellular telephone network. An MS (MS) comprises a first switching device (2) arranged to switch IMSI from said IMSI in use to a 5 new IMSI. The system comprises an HLR (HLR) associated with a second switching device (3) arranged to switch IMSI in the HLR (HLR) correspondingly. The first and second switching devices (2, 3) are arranged to switch IMSI at selected points in time. The second switching device (3) comprises an identifying means (4) arranged to identify the new IMSI in the 10 HLR (HLR) as the subscriber. The invention also refers to a method for an IMSI handling system.

### TECHNICAL FIELD

The invention concerns an IMSI handling system for a cellular telephone network. The IMSI handling system comprises at least one MS and an HLR, wherein the MS is arranged to intercommunicate with the HLR for establishing a communication link within the network. The MS comprises an IMSI used by the HLR for identifying the MS as a subscriber in the network during registration of the subscriber to the network. The invention also concerns a method for an IMSI handling system.

### BACKGROUND

The following terminology that is used in the GSM standard, is also used throughout the present application for describing the invention:

AUC The Authentication Center is a unit associated with an HLR and it provides one or more authentication triplets for an authentication process when an MS tries to register into the network. The triplet consists of: User authentication request (RAND, 128 bit random number); User authentication response (RES, 32 bit number); and a session key Kc (64 bit number). The MS uses a ciphering key Ki together with Kc for air interface ciphering. The triplet parameters are thus generated with the key Ki known in the MS on a SIM why AUC needs an IMSI as input to generate the triplets.

SIM The Subscriber Identity Module is a smart card with subscriber data and data processing capabilities.

IMSI International Mobile Subscriber Identity is a 15 to 18 byte number assigned to each SIM which uniquely identifies a GSM user world-wide. It is used for internal operations in GSM network and consists of three parts: Mobile Country Code (MCC, 3 digits), Mobile Network Code (MNC, 2-3 digits) and the Mobile Subscriber Identity Number (10 digits). An IMSI is always associated to one particular HLR.

HLR The Home Location Register stores all subscriber relevant information: Static information is; Definition of IMSI and MSISDN association, Subscribed services (Call forwarding, Roaming restrictions, etc.); Dynamic information is; Current location area (LA), VLR and MSC, Mobile Subscriber Roaming Number (MSRN). The MSC also supports charging and accounting and may manage millions of customers' information.

LA A Location Area is a number of cells defined by the mobile operator throughout which a GSM mobile will be paged.

MS Mobile Station, i.e. a user equipment, e.g. a cellular phone or a computer.

BTS At least one Base Transceiver Station is connected to a base station controller BSC. The BTS(s) are capable of making connections with mobile stations MS comprising mobile equipment ME and subscriber identity modules SIM using channels of the so called air interface.

BSC The Base Station Controller provides, classically, the intelligence behind the BTSs. Typically a BSC has tens or even hundreds of BTSs under its control. The BSC handles allocation of radio channels, receives measurements from the mobile phones, controls handovers from BTS to BTS (except in the case of an inter-BSC handover in which case control is in part the responsibility of the Anchor MSC). A key function of the BSC is to act as a concentrator where many different low capacity connections to BTSs (with relatively low utilization) become reduced to a smaller number of connections towards the Mobile Switching Center (MSC) (with a high level of utilization). Overall, this means that networks are often structured to have many BSCs distributed into regions near their BTSs which are then connected to large centralized MSC sites.

The BSC is not only a BTS controller but, for some vendors, a full switching center, as well as an SS7 node with connections to the MSC, as well as the Serving GPRS Support Node (SGSN) when using packet data services. The BSC also provides all the required data to the Operation Support Subsystem (OSS) as well as to the performance measuring centers. The databases for all the sites, including information such as carrier frequencies, frequency hopping lists, power reduction levels, receiving levels for cell border calculation, are stored in the BSC. This data is obtained directly from radio planning engineering which involves modeling of the signal propagation as well as traffic projections.

MSC The Mobile Switching Centre connects to other MSCs via an interface. It also connects to BSCs via an interface. The MSC handless all signaling functions necessary for connection setup and release (using SS7 protocols), handover between BSCs and handover betweens MSCs. The MSC provides the following Supplementary Functions: Call forwarding, Multi-party calls, Reverse Charging, etc. The MSCs are capable of establishing signaling connections with the home location register HLR and the authentication centre AUC.

GMSC Gateway MSC is an interface for a PMLN (Public Land Mobile Network) to other networks such as PSTN, ISDN and data networks (X.25).

MSISDN Mobile Station International Subscriber Directory Number, the number dialed to call a mobile phone. The MSISDN number of a user, i.e. a subscriber, is associated with the IMSI number and is stored in an HLR.

VLR Visiting Location Register is a database that stores all important information about users in the region managed by the VLR, i.e., in the LA(s) associated with the VLR. This includes IMSI, triplets and HLR address. The VLR is updated as the mobile moves into new a LA. The HLR is updated as the MS moves into an area controlled by a different VLR and required information regarding the subscriber is copied from the HLR to the new VLR.

TMSI Temporary Mobile Subscriber Number is used during a session instead of IMSI to hide IMSI for protecting subscriber identity. It is assigned by the VLR at the current location of the MS. The TMSI is four bytes long.

W-CDMA Wideband Code Division Multiple Access is a type of 3G cellular network.

Protecting subscriber identity means the concealment of the identity of a user of a telecommunications network from outsiders. Protection of identity is of special importance in mobile communications systems, where the subscriber and the network identify themselves to each other before the connection is made. If subscriber identity is transferred unprotected, it is possible to follow the movements of the subscriber by monitoring the radio connections established between the subscriber and the network. In addition, by protecting the subscriber's identity it is possible to considerably complicate the deciphering of data communications.

In GSM a subscription is identified by the IMSI defined on the SIM card used in the mobile phone. When an MS, for example a cellular phone, is powered on or roams into a network, the MS registers with the network to associate itself with the network to enable calls from and to the mobile phone. The registration is performed according to the process outlined in the appended FIG. 1, where the MS establishes a communication link via a channel request and response via a BTS and a BSC, followed by an authentication request and response using an MSC, VLR and HLR. It is known to use TMSI for hiding the IMSI. However, although TMSI may be activated by the network operator to hide the user, the IMSI is visible in the air interface during the registration process until a TMSI has been assigned. This enables monitoring/tracking and eavesdropping of individual subscribers, also after TMSI has been applied, since the TMSI becomes known to the third party.

This may be an unacceptable risk for high profile VIP users in higher governmental and national security functions, etc. Furthermore, a third party may utilize equipment that can be used on the MS so that the MS is triggered to send out its IMSI because it believes that a new registration shall be made. Hence, a third party can always get hold of the IMSI and may then track/monitor the MS.

U.S. Pat. No. 6,373,949 discloses a system comprising an MS and an HLR and where the IMSI is hidden in an encrypted message from the MS to the HLR. The message is transparent with regard to the HLR address so the encrypted message from the MS can find its way to the correct HLR. In the HLR the message is decrypted and the IMSI is used in the HLR in a normal way for identifying the user and for establishing a communication link. One disadvantage with the system is that the MS always uses the same IMSI. This is a disadvantage since a third party having broken the code immediately can identify the user/MS via the IMSI.

For the reasons above, there still exists a need for an alternative and improved handling of the IMSI so that a third party is hindered from tracking/monitoring the movement of an MS within a GSM based network.

### SUMMARY

The object of the present invention is to meet the above needs and to find a better solution for the handling of the IMSI. The invention concerns an IMSI handling system for a telephone network, such as GSM or W-CDMA. The IMSI handling system comprises at least one MS and a HLR. The invention also concerns a method for such a system. The invention intends to use the existing standards within the network with regard to, for example, protocols for establishing a communication link. The invention may be used on all networks or all systems where the MS comprises an IMSI used by the HLR for identifying the MS as a subscriber in the network during registration of the subscriber to the network and where the MS is arranged to intercommunicate with the HLR for establishing a communication link within the system.

The invention is characterized in that the MS comprises a first switching device arranged to switch IMSI from the IMSI currently in use to a new IMSI and that the HLR is associated with a second switching device arranged to switch IMSI in the HLR correspondingly. The first and second switching devices are arranged to switch IMSI at selected points in time, i.e., e.g. periodically or non-periodically, or at selected time intervals of different or the same length, or at a point in time decided by the user of the MS or the controller of the HLR. The second switching device comprises an identifying means that identifies the new IMSI in the HLR as the subscriber.

One advantage of the invention is that almost complete anonymity can be provided for MS users without changing the GSM standard, i.e. the system is in line with existing functionality and standard. One further advantage is that the system can be implemented without cumbersome consumption of IMSI resources. Yet another advantage is that the system can be implemented without consent or cooperation from serving network operators making the system globally available from day one after implementation.

Furthermore, the solution offers an alternative and complement to existing security solutions that rely solely on encryption of the media stream. The present invention hides the identity of the subscriber by switching IMSI which makes it hard for a third party to track/monitor the subscriber, i.e. the MS, since the IMSI is changing frequently. The monitoring third party will notice that the IMSI disappears which will be interpreted as a switch off of the MS. If the old IMSI then is used by a second MS at a different location the third party will interpret this as the subscriber/MS has changed location. The present invention thus makes it difficult for the third party to know what to search for in order to intercept communication from a dedicated subscriber/MS.

The invention may be realized in the existing GSM system in number of ways and the second switching device may be arranged to switch IMSI synchronously with the first switching device or may be arranged to switch IMSI non-synchronously.

In both cases the first switching device advantageously comprises a first IMSI generating device arranged to generate the new IMSI before the switch is taking place and the second switching device comprises a second IMSI generating device arranged to generate the same new IMSI as the first IMSI generating device before the switch is taking place. The second switching device may form part of the HLR, but may also be arranged as an external unit connectable to the HLR. The external unit may be a computer or the like that can handle databases and perform computational tasks.

The first and second IMSI generating devices may be arranged in different ways for generating the new IMSI. For example, the first and second IMSI generating devices may comprise information about which IMSIs that are allowed when generating the new IMSI. This may be realized by the first and second IMSI generating devices comprising lists of predetermined IMSIs. The first IMSI generating device and the second IMSI generating device may be arranged to use the lists when generating the new IMSI. For example, the first and second IMSI generating devices may simply pick a new IMSI from the list according to a predetermined routine. The list may be implemented in its entirety in the MS and the HLR or may implicitly be known to the MS and the HLR by use of an algorithm calculating a new MS. The algorithm is then programmed to use only certain IMSIs. The algorithm may be used by a processor device arranged to use the algorithm when generating the new IMSI. One processor device may be comprised in the MS and one processor device may be comprised in the HLR. In the MS, the processor device may be comprised in the first IMSI generating device or it may be comprised in an external device connectable to the MS. The first switching device may be arranged in the SIM of the MS, in another part of the MS, or in an external device connectable to the MS. The processor device in the MS may be physically formed in an existing printed circuit board of the SIM or of the MS or may be physically formed in a new device connectable to already existing devices in the MS. The processor device in the MS may also be implemented as computer software in an already existing circuit board.

When the second switching device is arranged to switch IMSI non-synchronously with the first switching device, the first switching device is arranged to switch to the new IMSI first and the identifying means is arranged to identify the new IMSI and to change the IMSI in the HLR. This may be realized by the first switching device comprising a cipher device arranged to write the new IMSI in cipher. The identifying means then comprises a deciphering device arranged to decipher the new IMSI. Here “write the new IMSI in cipher” means that the IMSI itself may be encrypted or that the new IMSI is non-encrypted but that the new IMSI is comprised in an encrypted information sequence from the MS to the HLR comprising information that can be used by the identifying means for connecting the new IMSI to the correct subscriber.

A combination of encryption and the present change of IMSI would provide an even stronger privacy for the users compared to relying only on the encryption of a known communication path.

### BRIEF DESCRIPTION OF THE DRAWINGS

The invention will below be described in detail in connection to a number of drawings, where;

FIG. 1 schematically shows a registration process according to prior art in a GSM system;

FIG. 2 schematically shows an MS and an HLR according to the invention;

FIG. 3 schematically shows an IMSI switch process according to an example of a first embodiment of the invention in a GSM system;

FIG. 4 schematically shows an IMSI switch process according to an example of a second embodiment of the invention in a GSM system, and where;

FIG. 5 schematically shows an IMSI switch process according to an example of a third embodiment of the invention in a GSM system.

### DETAILED DESCRIPTION

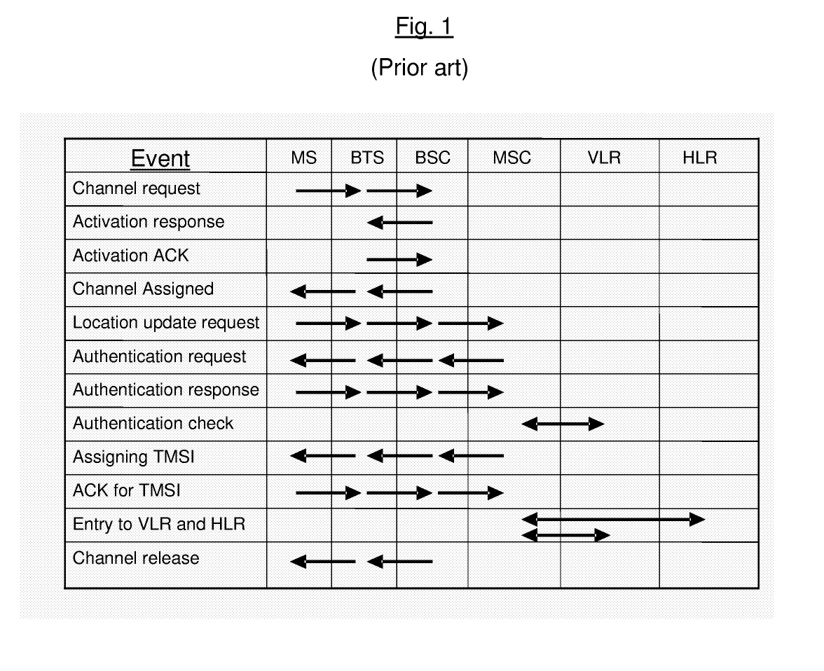

FIG. 1 shows a registration process according to prior art in a GSM-system network. FIG. 1 is a flowchart schematic for the registration process and in FIG. 1 arrows show the flow of information between the different units comprised in the system. The units are; MS, BTS, BSC, MSC, VLR and HLR, which units all have been defined in connection with the above background art discussion. The flowchart should be read in an order from the channel request to the channel release. In GSM a subscription is identified by the IMSI defined on the SIM card used in the mobile phone. When an MS, for example a cellular phone, is powered on or roams into a network, the MS registers with the network to associate itself with the network to enable calls from and to the mobile phone.

In FIG. 1 the registration process is as follows: the MS establishes a communication link via a channel request to the BSC via the BTS; the BSC starts an activation process by sending an activation response signal to the BTS; the BTS then acknowledges the activation response signal by sending an activation acknowledgment signal (ACK) to the BSC; the BSC then assigns a channel to the MS via the BTS; the MS sends a location update request to the MSC via the BTS and the BSC; the MSC sends an authentication request to the MS via the BSC and the BTS; the MS sends an authentication response to the MSC via the BTS and the BSC; the MSC makes an authentication check with the VLR; after the authentication check the MSC assigns a TMSI and sends the TMSI to the MS via the BSC and the BTS; the MS acknowledges (ACK) the TMSI to the MSC via the BTS and the BSC; the MSC then communicates with the VLR and the HLR for entry into the registers in order to correlate the TMSI with the IMSI and thus with the subscriber; finally the BSC releases a channel to the MS via the BTS.

Each mobile subscriber has a home public land mobile network HPLMN operated by an operator with which the subscriber has concluded an agreement. The user's subscriber data is stored in the HLR of his/her home HPLMN and the related authentication centre AUC. The AUC has all the data necessary for verifying the authenticity of the identity communicated by the user. In the HLR, the mobile subscriber international ISDN number MSISDN can be linked to the user's IMSI. In addition, information on the services ordered by the subscriber as well as the user's current location to an accuracy within the visitor location register VLR address is stored in the HLR. No subscriber can be registered with more than one VLR at any given time.

The VLR located in association with the MSC is also used to maintain data on the location of users registered with the applicable visitor location register to an accuracy of a so called location area In addition to the services offered by the HPLMN. A subscriber can use the services available in those other VPLMNs with which his/her own operator has signed a roaming agreement.

Through the mobile services switching center MSC, mobile communications systems are linked to fixed telephone networks, such as a public switched telephone network PSTN or an integrated services digital Network ISDN. Several BTSs are connected to a BSC. The base transceiver stations are capable of making connections with MSs consisting of mobile equipment ME and SIM using channels of the so called air interface.

In mobile communications systems representing prior art, the objective is to transmit subscriber identity protected across the air interface. In FIG. 1, the known GMS system uses a temporary mobile subscriber identity TMSI to conceal the user's international mobile subscriber identity IMSI. However, the IMSI is transparent in the air-interface until the TMSI has been established. The problems with prior art has been discussed above.

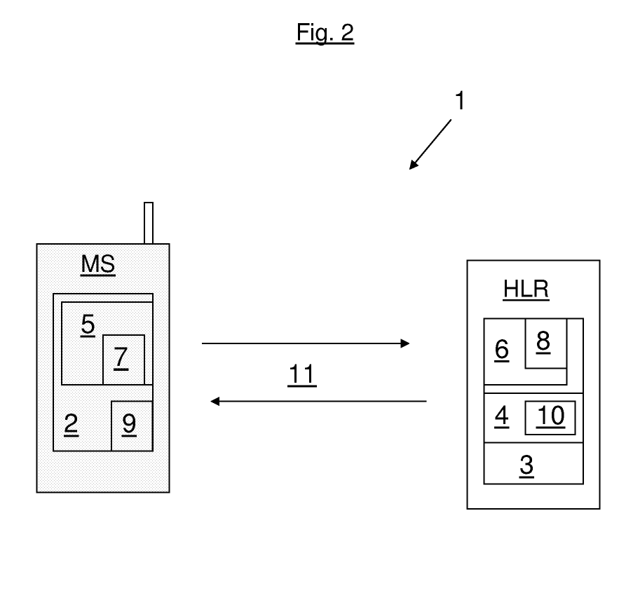

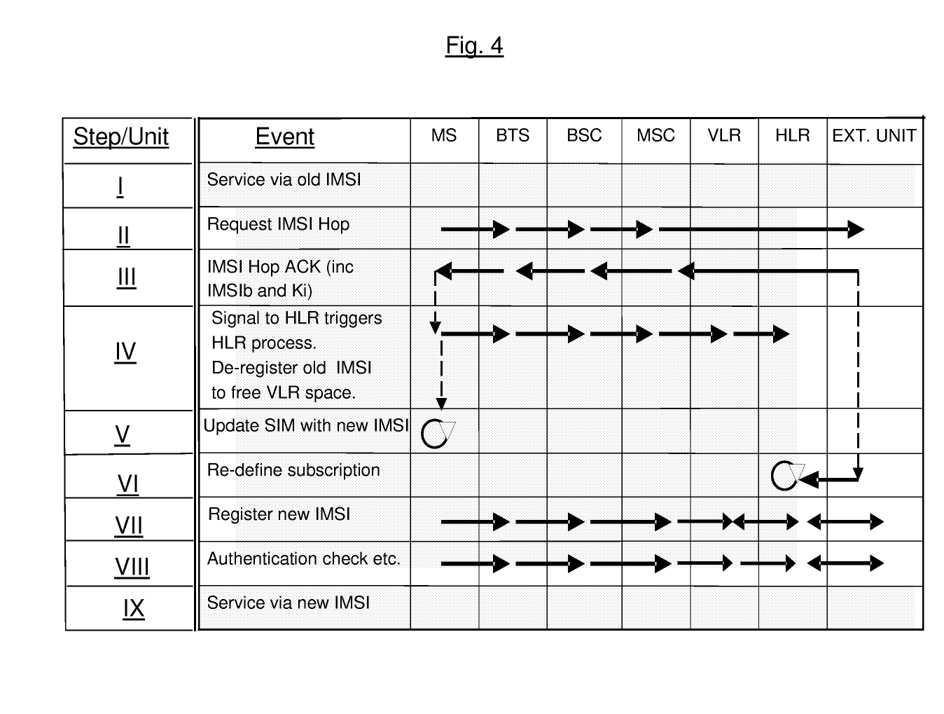

FIG. 2 schematically shows an MS and an HLR according to the invention. The IMSI switch process is performed by an IMSI handling system 1 for a GSM telephone network system comprising at least one MS and the HLR. The MS is arranged to intercommunicate with the HLR for establishing a communication link via the above described units (not shown in FIG. 2). The MS comprises an IMSI identifying the MS as a subscriber and the MS is arranged to transmit the IMSI to the HLR for registration with the HLR during registration of the subscriber to a network. The MS comprises a first switching device 2 arranged to switch IMSI from an old IMSI to a new IMSI. The HLR is associated with a second switching device 3 arranged to switch IMSI in the HLR correspondingly, and the second switching device 3 comprises an identifying means 4 that identifies the new IMSI in the HLR as the original subscriber. In FIG. 2 the second switching device 3 is comprised in the HLR, but the second switching device 3 may be comprised in an external unit (see FIG. 4) being coupled to the HLR so that the external unit may handle the IMSI switch process and the identification process.

The first switching device 2 comprises a first IMSI generating device 5 arranged to generate the new IMSI before the switch is taking place. The second switching device 3 comprises a second IMSI generating device 6 arranged to generate the same new IMSI as the first IMSI generating device 5 before the switch is taking place.

The first and second IMSI generating devices 5, 6 comprise information about which IMSIs that are allowed when generating the new IMSI. The information may be in the form of a list of predetermined IMSIs that the first and second IMSI generating devices 5, 6 use for generating the new IMSI. The list may be in the form of a number of IMSIs that have been allocated to a certain user or organization. The list may be comprised as a sub-unit in an already existing HLR or may form a new HLR controlled by the organization that has been creating the new HLR. Here “creating” refers to the case where an organization, or a person, has requested a list of IMSIs to be managed/controlled separately from the normal IMSIs. The allowable IMSIs may be managed in an external unit, for example a computer, connected to the HLR, or may be managed in the already existing HLR. The allowable IMSIs may be a chronological sequence of numbers or may be a random set of numbers.

In FIG. 2 the first and second IMSI generating devices 5, 6 comprise a first processor device 7 and a second processor device 8 respectively. The first and second processor devices 7, 8 use an algorithm when generating the new IMSI. The algorithm may use a starting number as a seed and may then generate a random allowable new IMSI, or may start with a first IMSI number and then skip to a new IMSI according to a predetermined plan.

The first switching device 2 may be arranged to switch IMSI synchronously with the second switching device 3. The algorithms used in the first and the second processor device 7, 8 then work simultaneously when generating the new IMSI. One benefit of this embodiment is that the switch of IMSI becomes easy since both the MS and the HLR becomes aware of the new IMSI at the same time and there can thus be no mismatch of IMSI number.

However, the first switching device 2 may be arranged to switch IMSI non-synchronously with the second switching device 3. The first processor device 7 then generates a new IMSI according to an algorithm and the second processor device 8 uses an algorithm that identifies the subscriber so that the identifying means 4 can allow the new IMSI so that the second switching device 2 may change the old IMSI to the new IMSI in the HLR accordingly. Before the switch is taking place, i.e. before the new IMSI is registered in the network, the identifying means identifies and couples the new IMSI to the subscriber identity accordingly. The identification of the IMSI may be done by the MS sending unique information to the HLR that can be used by the second processor device 8 for extracting information regarding the identity of the IMSI. The identifying means 4 then uses the information from the second processor device 8 so that the identifying means 4 correlates the IMSI to the correct subscriber.

The first switching device 2 may therefore comprise a cipher device 9 arranged to write the new IMSI in cipher and to thereby create the unique information. The identifying means 4 may correspondingly comprise a deciphering device 10 arranged to decipher the new IMSI. The cipher devices 9, 10 may use, for example, a hash function previously known in the field of cryptography. A cryptographic hash function is a hash function with certain additional security properties to make it suitable for use as a primitive in various information security applications, such as authentication and message integrity. A hash function takes a long string (or message) of any length as input and produces a fixed length string as output, sometimes termed a message digest or a digital fingerprint.

The unique information may also be in the form of geographical position of the MS. This information is sent to the HLR in any way and the identifying means 4 may identify the MS by use of an algorithm in the second processor device 8 comprising information on where the subscribers is supposed to be at a certain point in time. The unique information may, however, be any other information that can be foreseen by the identifying device, i.e. the identifying device is being programmed to recognize certain features and to couple them to the subscriber.

In FIG. 2, the first switching device 2 is arranged in the SIM of the MS, but may be arranged in another part of the MS, or in an external device connectable to the MS.

The IMSI handling system may be controlled automatically by the MS and the HLR according to a selected program routine. The IMSI handling system may also be controlled manually by the user and in such a case the MS is arranged to allow a user to control the system by, for example, pressing a key on the MS.

In FIG. 2 the air interface is denoted with number 11.

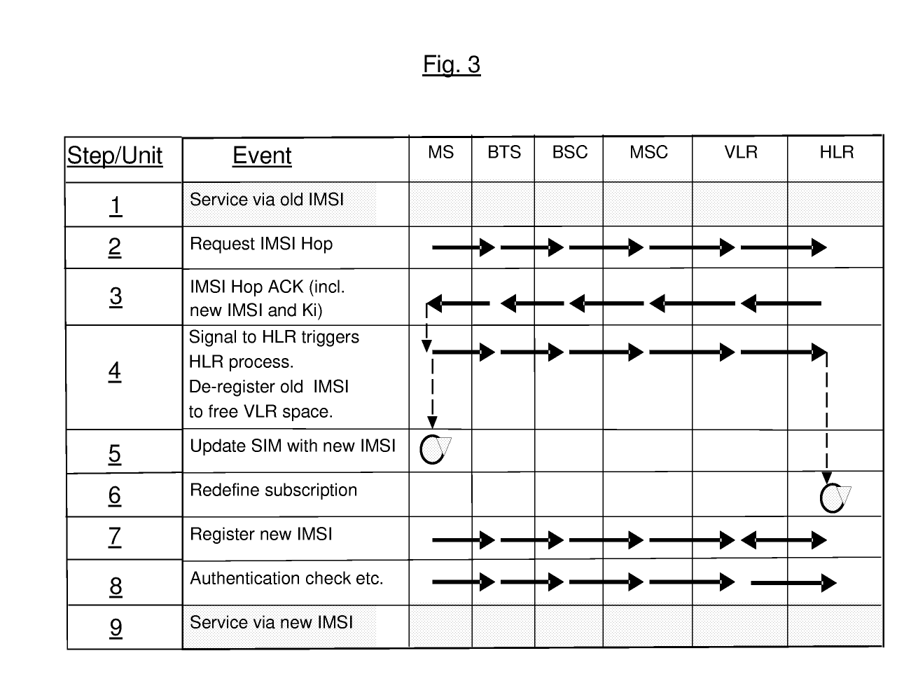

FIG. 3 schematically shows an IMSI switch process according to an example of a first embodiment of the invention in a GSM system comprising the same units as in FIG. 1 and in FIG. 2. FIG. 3 is a flowchart schematic for the registration process according to the invention and in FIG. 3 arrows show the flow of information between the different units comprised in the system. The flowchart should be read from step 1 to step 9 and the steps will be further discussed below.

Step 1. The system uses an old IMSI and the services provided for the MS, e.g. telephone calls, etc., use the old IMSI for the designated channel previously released. The old IMSI is thus transparent for the BTS, BSC, MSC, VLR, and HLR units.

Step 2. The MS requests a change of the old IMSI by an IMSI Hop Request being sent to the HLR via the BTS, BSC, MSC, and VLR units.

Step 3. The HLR generates a new IMSI by use of the second IMSI generating device 6 and a new key Ki for ciphering the air interface. The HLR acknowledges the request in step 2 and an acknowledgement signal IMSI Hop ACK is sent to the MS via the BTS, BSC, MSC, and VLR units. The IMSI Hop ACK comprises the new IMSI and the new Ki that ciphers the message and makes the payload, i.e. the IMSI, in the IMSI Hop ACK hidden in the air interface for a third party. Additional ciphering may be added for protecting the IMSI from detection. When the MS receives the IMSI Hop ACK, the first switching device 2 in the MS extracts the IMSI from the IMSI Hop ACK for use in the MS. Even though the first IMSI generating device 2 does not generate a new IMSI on its own in this embodiment, it should be understood that the first IMSI generating device 5 generates the new IMSI in the process of extracting the IMSI from the IMSI Hop ACK.

Step 4. The MS sends info to the VLR to de-register the old IMSI in the VLR in order to free VLR space. However, in another embodiment the de-registration part may be opted out since it can be replaced by the use of the GSM standard time-out de-registration in the VLR when the VLR detects that the old IMSI has not been active for period of time. Furthermore, in step 4 a VLR signal is sent from the MS to the VLR and to the HLR in order to trigger an HLR process according to step 6.

Step 5. The MS switches to the new IMSI, for example by updating the SIM, by use of the first IMSI generating device.

Step 6. The HLR redefines the subscriber to be coupled to the new IMSI. The identifying means 4 makes preparations to couple the new IMSI to the correct MSISDN, i.e. the subscriber's MSISDN. The new IMSI may be coupled to a temporary MSISDN for a period of time starting with the generation of a new IMSI to step 6. Steps 5 and 6 may be done simultaneously or may be done so that the VLR has redefined the subscription before the SIM is updated with the new IMSI or after the SIM is updated with the new IMSI. However, the important thing is that the HLR is prepared to allow the new IMSI when asked by the VLR in step 7.

Step 7. The MS registers the new IMSI with the VLR and the HLR. Dependent on the action under step 6, the first switching device 2 may be arranged to wait for a selected period of time so that the HLR becomes ready to allow the new IMSI when the VLR asks the HLR during the registration of the new IMSI. During step 7 the VLR and HLR exchange information and the AUC, being associated with the HLR, creates one or more triplets to be copied by the VLR. Other GSM standard information may also be copied from the HLR to the VLR. In the case where the HLR uses a temporary MSISDN, the temporary MSISDN is de-coupled from the new IMSI and the new IMSI is coupled to the subscriber's correct MSISDN. This action is performed by the HLR and is not accessible for the third party. The third party only sees that the old IMSI disappears and does not become aware of the switch. If a second subscriber also makes a change of IMSI and uses the old IMSI from the MS as a new IMSI at another location, the third party wrongly assumes that the subscriber has changed position to the new location. This has the benefit that the third party cannot track an MS via the subscriber's IMSI.

Step 8. The MS makes an authentication check with the VLR and the VLR accordingly makes a check with the HLR regarding the new IMSI and the subscriber. An emergency call is an exception to this and step 8 may then be left out.

Step 9. The services are restored for the MS by use of the new IMSI.

One advantage of the invention is that the new IMSI will show up in the VLR as a new unrelated MS in the visiting network. This is possible since the new IMSI is defined in the MS and the HLR, both which are controlled by the same organization without interference of the operator of the network. Hence, the IMSI switch is out of control of a third party. The VLR only checks with the HLR if the new IMSI is known by the HLR and when the HLR acknowledges, the VLR accepts info from the HLR and is not aware of what goes on in the HLR, or beyond the HLR. Hence, the redefinition of the subscriber's MSISDN to correspond to the new IMSI in the HLR is not open to a third party, but the HLR recognizes the new IMSI when asked by the VLR, why the new defined IMSI is accepted by the network as a new MS.

Furthermore, if a third party has once forced the MS to reveal its IMSI and the IMSI is changed the third party needs to try again to coerce the MS to reveal the new IMSI in order to be able to continue monitoring the MS. This pattern has to be repeated for every change of IMSI and forces the third party to act in such a way that it becomes easy to detect the activities of the third party. For the reasons above the third party will get confused because of the IMSI switches and the monitoring abilities for the third party therefore become impaired. The present invention thus makes it difficult for a third party to continuously monitor/track a certain MS.

FIG. 4 schematically shows an IMSI switch process according to an example of a second embodiment of the invention in a GSM system comprising the same units as described in FIGS. 1, 2, and 3. However, in FIG. 4 the identification device and the second switching device are arranged in an external unit (hereinafter called EXT. UNIT as in the drawing) from the HLR. Hence, in FIG. 4 the EXT. UNIT replaces the HLR with regard to the handling of the IMSI switch process.

FIG. 4 is a flowchart schematic for the registration process according to the invention and in FIG. 4 arrows show the flow of information between the different units comprised in the system. The flowchart should be read from step roman I to step roman IX, and the steps will be further discussed below.

Step I. The system uses an old IMSI and the services provided for the MS, e.g. telephone call, etc., use the old IMSI for the designated channel previously released. The old IMSI is thus transparent for the BTS, BSC, MSC, VLR, and HLR units.

Step II. The MS requests a change of the old IMSI by an IMSI Hop Request being sent to the EXT. UNIT via the BTS, BSC, and MSC units.

Step III. The EXT. UNIT generates a new IMSI by use of the second IMSI generating device 6 and a new key Ki for ciphering the air interface. The EXT. UNIT acknowledges the IMSI Hop Request in step II and an acknowledgement signal IMSI Hop ACK is sent to the MS via the BTS, BSC, and MSC units. The IMSI Hop ACK comprises the new IMSI and the new Ki that ciphers the message and makes the payload, i.e. the IMSI, in the IMSI Hop ACK hidden in the air interface for a third party. Additional ciphering may be added for protecting the IMSI from detection. When the MS receives the IMSI Hop ACK, the first switching device 2 in the MS extracts the IMSI from the IMSI Hop ACK for use in the MS. Even though the first IMSI generating device 5 does not generate a new IMSI on its own, it should be understood that the first IMSI generating device 5 generates the new IMSI in the process of extracting the IMSI from the IMSI Hop ACK.

Step IV. The MS sends info to the VLR to de-register the old IMSI in the VLR in order to free VLR space. However, in another embodiment the de-registration part may be opted out since it can be replaced by the use of the GSM standard time-out de-registration in the VLR when the VLR detects that the old IMSI has not been active. Furthermore, in step IV a VLR signal is sent from the MS to the VLR and to the HLR in order to trigger an HLR process according to step VI.

Step V. The MS switches to the new IMSI, for example by updating the SIM, by use of the first IMSI generating device.

Step VI. The EXT. UNIT gives information to the HLR so that the HLR can redefine the subscriber to be coupled to the new IMSI. The identifying means makes preparations to couple the new IMSI to the correct MSISDN, i.e. the subscriber's MSISDN. The new IMSI may be coupled to a temporary MSISDN for a period of time starting with the generation of a new IMSI to step 6. Steps 5 and 6 may be done simultaneously or may be done so that the VLR has redefined the subscription before the SIM is updated with the new IMSI or after the SIM is updated with the new IMSI. However, the important thing is that the HLR is prepared to allow the new IMSI when asked by the VLR in step VII.

Step VII. The MS registers the new IMSI with the VLR and the HLR according to normal GSM procedures. The EXT. UNIT communicates with the HLR during the registration process in order for the second switching device and the identifying means to be able to accept the new IMSI so that the HLR can accept the new IMSI when asked by the VLR. Depending on the action performed under step VI, the first switching means may be arranged to wait for a selected period of time so that the HLR becomes ready to allow the new IMSI when the VLR asks the HLR during the registration of the new IMSI. During step VII the VLR and HLR exchange information and the AUC in the HLR creates one or more triplets to be copied by the VLR. Other GSM standard information may also be copied from the HLR to the VLR. In the case where the HLR and the EXT. UNIT use a temporary MSISDN, the temporary MSISDN is de-coupled from the new IMSI and the new IMSI is coupled to the subscriber's correct MSISDN. This action is performed by the HLR and the EXT. UNIT and is not accessible for the third party. The third party only sees that the old IMSI disappears and does not become aware of the switch. If a second subscriber also makes a change of IMSI and uses the old IMSI from the MS as a new IMSI at another location, the third party wrongly assumes that the subscriber has changed position to the new location. This has the benefit that the third party cannot track an MS via the subscribers IMSI.

Step VIII. The MS makes an authentication check with the VLR and the VLR accordingly makes a check with the HLR regarding the new IMSI and the subscriber. An emergency call is an exception to this and step 8 may then be left out.

Step IX. The services are restored for the MS by use of the new IMSI.

Apart from the benefits discussed in connection to FIG. 3, the benefit of this embodiment, where an external system manages the HLR subscription redefinition, is that no added HLR functionality is required since the new node EXT. UNIT operates through existing user interfaces.

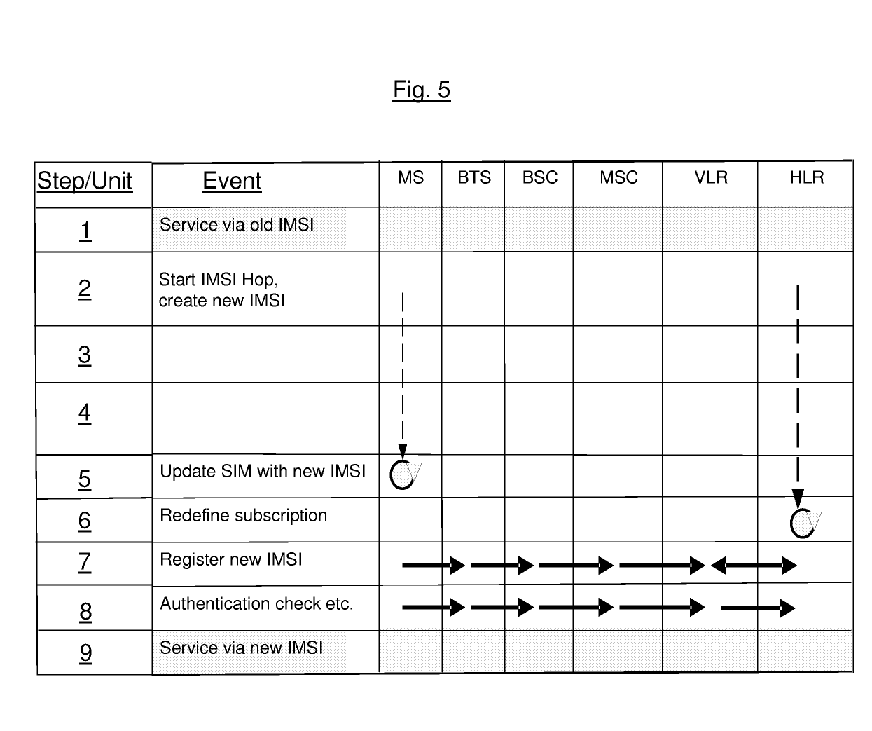

FIG. 5 schematically shows an IMSI switch process according to an example of a third embodiment of the invention in a GSM system. FIG. 5 shows that the second switching device 6 and the identification means 4 are comprised in the HLR as in FIG. 3, but it should be understood that the embodiment described in FIG. 5 could be used with the second switching device 6 and the identification means 4 are comprised in the EXT. UNIT in FIG. 4.

In FIG. 5 a number of steps are discussed. The number of steps corresponds to the number of steps in FIGS. 3 and 5 in order to facilitate the description of the invention and to clearly point out certain advantages.

Step 1. The system uses an old IMSI and the services provided for the MS, e.g. telephone calls, etc., use the old IMSI for the designated channel previously released. The old IMSI is thus transparent for the BTS, BSC, MSC, VLR, and HLR units.

Step 2. The IMSI handling system 1 is arranged to start the process of IMSI Hop which refers to the generation of a new IMSI and the switch of IMSI at both the MS and the HLR. The process can be initiated automatically according to a pre-defined algorithm where the first and second switching devices 2, 3 are controlled to generate a new IMSI via the first and second IMSI generating devices 5, 6 respectively. The process may also be started manually by the user of the MS ordering the IMSI handling system to start the process of IMSI Hop. The first and second switching devices 2, 3 may deliver the new IMSI simultaneously or may perform one process before the other. The first switching device 2 may also be arranged to switch IMSI synchronously with the second switching device 3 or may be arranged to switch IMSI asynchronously with the second switching device 3.

The HLR generates a new IMSI by use of the second IMSI generating device 5 and a new key Ki for ciphering the air interface. Additional ciphering may be added for protecting the IMSI from detection.

The third embodiment does not make use of step 2, step 3 or step 4 in FIGS. 3 and 4, since the MS and the HLR operate separately without intercommunication. Hence, there is no need for an IMSI Hop Request or for an IMSI Hop ACK. However, de-registration of the old IMSI may be performed during the IMSI switch in the third embodiment, or may be left out for the automatic time-out de-registration.

Step 5. The MS switches to the new IMSI, for example by updating the SIM, by use of the first IMSI generating device.

Step 6. The HLR redefines the subscriber to be coupled to the new IMSI. The identifying means makes preparations to couple the new IMSI to the correct MSISDN, i.e. the subscriber's MSISDN. The new IMSI may be coupled to a temporary MSISDN for a period of time starting with the generation of a new IMSI to step 6. Steps 5 and 6 may be done simultaneously or may be done so that the VLR has redefined the subscription before the SIM is updated with the new IMSI or after the SIM is updated with the new IMSI. However, the important thing is that the HLR is prepared to allow the new IMSI when asked by the VLR in step 7.

Step 7. The MS registers the new IMSI with the VLR and the HLR. Depending on the action performed under step 6, the first switching device 2 may be arranged to wait for a selected period of time so that the HLR becomes ready to allow the new IMSI when the VLR asks the HLR during the registration of the new IMSI. During step 7 the VLR and HLR exchange information and the AUC in the HLR creates one or more triplets to be copied by the VLR. Other GSM standard information may also be copied from the HLR to the VLR. In the case where the HLR uses a temporary MSISDN, the temporary MSISDN is de-coupled from the new IMSI and the new IMSI is coupled to the subscriber's correct MSISDN. This action is performed by the HLR and is not accessible for the third party. The third party only sees that the old IMSI disappears and does not become aware of the switch. If a second subscriber also makes a change of IMSI and uses the old IMSI from the MS as a new IMSI at another location, the third party wrongly assumes that the subscriber has changed position to the new location. This has the benefit that the third party cannot track an MS via the subscriber's IMSI.

Step 8. The MS makes an authentication check with the VLR and the VLR accordingly makes a check with the HLR regarding the new IMSI and the subscriber. An emergency call is an exception to this and step 8 may then be left out.

Step 9. The services are restored for the MS by use of the new IMSI.

In addition to the above described advantages of the invention, one benefit of the third embodiment is that there is no signaling between the MS and the HLR over the air interface which means that a third party monitoring the air interface cannot find any information in the communication between the MS and the HLR that could reveal that a switch is taking place or is about to take place. Another advantage of the third embodiment is that the network operator, governing the VLR, cannot see that the MS changes IMSI, but the network operator will consider the new IMSI as a new MS allowed by the HLR according to standard procedures of the system. The standard procedure refers to the procedure when a new MS arrives in the cell and tries to associate with the system in the cell.

The third embodiment may also use an EXT. UNIT according to FIG. 4. The EXT. UNIT then comprises the second IMSI switch device, the second IMSI generating device and the identifying means.

The invention is not limited to the above described embodiments, but further embodiments are possible within the scope of the claim. For example, the MS may comprise a SIM with dual SIM function (two SIM in one) enabling “soft swap” of IMSIs, i.e. the current service using the old IMSI is not terminated until the new service using the new IMSI has been associated to the network.

Furthermore, the VLR may be equipped with a further functionality allowing the VLR to function as a filter so that foreign country numbers may be used. The present invention may comprise a SIM application toolkit comprising an array of IMSIs in the MS. The array may comprise, for example, three elementary files on the SIM; a first one that is the current active IMSI, a second one that is the next IMSI to be used when IMSI switch is requested, and a third one that downloads an IMSI via the first IMSI generating device to be used after the next swap (i.e. a buffer so that the download can take place prior to the new IMSI is requested). The IMSI switch may be initiated periodically or for example after each call is completed. If call set up is made using the SIM application toolkit above, the SIM application can initiate the IMSI swap and the new IMSI can be delivered by downloading over the air to the predefined IMSI array.

In all the above embodiments, the new IMSI number may be used only during a selected time period whereafter the old IMSI is used again. This has the advantage that the number of IMSIs used by the IMSI handling system may be kept to a minimum.

The invention may be used together with specially adapted MSs where each MS has a mobile identification number corresponding to a predetermined group of users. This identification number may be used by the identifying means may when identifying new IMSIs to be associated with a certain subscriber identity according to the above.

The IMSI handling system may also comprise a device and a process for altering information in the MS so that the new IMSIs may be coupled to different MS identities. This step would increase the difficulty for the third party to trace/monitor the MS in the network. Said device may be comprised in the first IMSI switch device and may be used to re-program the software in the MS.

The invention may be used in a W-CDMA network or any other system comprising an MS, VLR and an HLR. In W-CDMA the MS may be any user equipment, for example a mobile telephone or a computer. In W-CDMA the BTS is called Node B and the BSC is called Radio Network Controller (RNC).

1. An International Mobile Subscriber Identity (IMSI), handling system for a cellular telephone network, said IMSI handling system comprising a Mobile Station (MS), and a Home Location Register, HLR (HLR), the MS being arranged to intercommunicate with the HLR for establishing a communication link within the network, the MS comprising an IMSI used by the HLR for identifying the MS as a subscriber in the network during registration of the subscriber to the network, the IMSI handling system comprising:
a first switching device in the MS arranged to switch IMSI from said IMSI in use to a new IMSI and
the HLR being associated with a second switching device arranged to switch IMSI in the HLR correspondingly with the first switching device, wherein the first and second switching devices are arranged to switch IMSI at selected points in time, and the second switching device comprising an identifying means arranged to identify the new IMSI in the HLR as the subscriber.

2. The IMSI handling system according to claim 1, wherein the second switching device is comprised in the HLR or the second switching device is arranged as an external unit from the HLR.

3. The IMSI handling system according to claim 1, wherein the first switching device comprises a first IMSI generating device arranged to generate the new IMSI prior to switching the IMSI.

4. The IMSI handling system according to claim 3, wherein the second switching device comprises a second IMSI generating device arranged to generate the same new IMSI as the first IMSI generating device prior to switching the IMSI.

5. The IMSI handling system according to claim 4, wherein the first and second IMSI generating devices comprise information about which IMSIs are allowed when generating the new IMSI.

6. The IMSI handling system according to claim 5, wherein the first and second IMSI generating devices each comprise a list of predetermined IMSIs that the first IMSI generating device is arranged to use for generating a new IMSI.

7. The IMSI handling system according to claim 4, wherein the first and second IMSI generating devices each comprise a processor device arranged to use an algorithm when generating the new IMSI.

8.-14. (canceled)

15. A method of handling an International Mobile Subscriber Identity (IMSI), in a cellular telephone network, using an IMSI handling system, said IMSI handling system comprising a Mobile Station (MS), and a Home Location Register (HLR), wherein the MS intercommunicates with the HLR for establishing a communication link within the network, the MS comprising an IMSI used by the HLR for identifying the MS as a subscriber in the network during registration of the subscriber to the network, the method comprising the steps of:
utilizing a first switching device in the MS for switching said IMSI in use to a new IMSIU, the HLR being associated with a second switching device;
the second switching device switching IMSI in the HLR correspondingly with the first switching device, wherein the first and second switching devices switch IMSI at selected points in time, and the second switching device; and
utilizing an identifying means for identifying the new IMSI in the HLR as the subscriber.

16. The method according to claim 15, wherein the second switching device is comprised in the HLR or that the second switching device is arranged as an external unit from the HLR.

17. The method according to claim 15, wherein the first switching device comprises a first IMSI generating device generating the new IMSI prior to switching the IMSI.

18. The method according to claim 17, wherein the second switching device comprises a second IMSI generating device generating the same new IMSI as the first IMSI generating device prior to switching the IMSI.

19. The method according to claim 18, wherein the first and second IMSI generating devices comprise information about which IMSIs are allowed when generating the new IMSI.

20. The method according to claim 19, wherein the first and second IMSI generating devices each comprise a list of predetermined IMSIs that the first IMSI generating device uses for generating an IMSI.

21. The method according to claim 18, wherein the first and second IMSI generating devices each comprise a processor device using an algorithm when generating the new IMSI.

22.-24. (canceled)

25. The method according to claim 15, wherein the first switching device comprises a cipher device writing the new IMSI in cipher and the identifying means comprises a deciphering device deciphering the new IMSI.

26.-27. (canceled)
